(19) United States
(12) Patent Application Publication
(10) Pub. No.: US 2015/0213716 A1
(43) Pub. Date: Jul. 30, 2015

(54) CENTRALIZED PARKING PAYMENT AND MONITORING SYSTEM USINGGEO LOCATION ENABLED DEVICES

(71) Applicant: Sunil GOEL, Gandhinagar (IN)

(72) Inventors: Adityakumar Akshaikumar Aggarwal, Shelby Township, MI (US); Sunil Goel, Gandhinagar (IN)

(21) Appl. No.: 14/423,127

(22) PCT Filed: May 2, 2013
(86) PCT No.: PCT/IN2013/000294

§ 371 Date: Feb. 21, 2015

(30) Foreign Application Priority Data
Aug. 27, 2012 (IN) 2490/MUM/2012

(51) Int. Cl. G08G 1/14

(52) U.S. Cl. CPC G08G 1/144; G08G 1/146

(57) ABSTRACT

The present invention describes the system of centralized parking payment and monitoring, which uses geo-location enabled devices such as iPhone, android, RIM devices, mobile phones, pagers and wireless mobile computers.

Using such system person can get a parking receipt; do payment of parking in the paid parking area directly from his geo-location enabled devices without any intervention of any attendant.

Simultaneously, police or parking manager can also check the virtual parking receipt of the vehicle in the centralized parking system using Geo-location enable mobile device.

The big differences between this new solution is compared to existing solution are (1)

All the current solutions are identifying a particular parking spot instead of looking at holistic view of parking on a whole street or an unmanned parking area. Geo-location devices have 5-25 meters inaccuracy in identifying a position i.e. 1-5 parking spots inaccuracy. As a result, geo-location device cannot locate a particular parking spot. Thereby no public parking solution exists based on the geo-location based devices alone. In our solution, we re-engineered the business problem and instead of looking at a particular parking spot, the new process is dependent of parking of particular section of street or an unmanned parking lot—which we refer to ‘Parking Area’. The characteristic of Parking Area is that pricing and business apply to Parking Area as a whole unit. We are able to provide solution just based on geo-location based devices by combining concept of Parking Area with design of with parking application along with enforcement application. Parking Area will be divided in three level hierarchy Admin1, Admin2 & Admin3. (2)

This solution does not need any new devices to be installed or parking spots to be marked and entered in the parking application. It uses geo-location enabled devices to identify the location of the parking place.

### FIELD OF INVENTION

The present invention describes the system of centralized parking payment and monitoring, which uses geo-location enabled devices such as iPhone, android, RIM devices, mobile phones, pagers and wireless mobile computers.

Using such system person can get a parking receipt; do payment of parking in the paid parking area directly from his geo-location enabled devices without any intervention of any attendant.

Simultaneously police or parking manager can also check the virtual parking receipt of the vehicle in the centralized parking system using Geo-location enabled device.

The big differences between this new solution is compared to existing solution are (1)

All the current solutions are identifying a particular parking spot instead of looking at holistic view of parking on a whole street or a unmanned parking area. Geo-location devices have 5-25 meters inaccuracy in identifying a position i.e. 1-5 parking spots inaccuracy. As a result, geo-location device cannot locate a particular parking spot. Thereby no public parking solution exists based on the geo-location based devices alone. In our solution, we re-engineered the business problem and instead of looking at a particular parking spot, the new process is dependent of parking of particular section of street or an unmanned parking lot—which we refer to ‘Parking Area’. The characteristic of Parking Area is that pricing and business apply to Parking Area as a whole unit. We are able to provide solution just based on geo-location based devices by combining concept of Parking Area with design of with parking application along with enforcement application. Parking Area will be divided in three level hierarchy Admin1, Admin2 & Admin3. (2)

This solution does not need any new devices to be installed or parking spots to be marked and entered in the parking application. It uses geo-location enabled devices to identify the location of the parking place.

### BACKGROUND OF INVENTION

This invention relates with the problem of car parking in paid parking areas, especially in the winter or summer season, or when the motorist parking his vehicle is not able to come back again to the vehicle to pay the charges for a further period, especially if he is busy in a business meeting, forget to pay the required charges, or late to pay a charge for an extended time, and allowing also the possibility to pay a fine for not paying the car parking charges. To avoid this problem, the present invention provides easier and an effective way for the same for car drivers and owners.

So far some of the inventions which try to resolve the same problem by using different means includes as per below:

WO2005031494 illustrate the use of Pager device and system for parking payment charges, wherein a vehicle-portable parking meter device for paying parking charges and for displaying paid parking time comprises a radio-operable two-way pager having a display screen and a contact or contactless storage chip. The pager can be installed in a vehicle so the screen is visible from outside.

KR20090084305 discloses a system and method for payment parking fee using mobile phone and parking machine, wherein a key input unit inputs a park application data including a mobile phone number and a parking time. A memory stores a parking fee of the parking lot and the inputted data through a key input unit, and an accounting unit calculates the parking fee based on the parking time which is inputted through the key input part.

KR20040080781 provides an apparatus and method for levying parking fees using cellular phone payment method, in which a settlement server is connected mobile phone wireless, wherein an entrance control unit issues a parking ticket including information related to an identification number and a telephone number connected to a settlement server and transmits the identification number and the incoming time to the settlement server. The settlement server calculates parking fees, charges the parking fees to a cellular phone, and permits the outgoing of a vehicle. An exit controller recognizes the identification number of the parking ticket and opens a gate of a parking lot.

KR20040070953 provides a method and an apparatus for managing parking by using a mobile phone are provided to effectively use a parking space by allowing a person to park with payment of a suitable charge and automatically operating a parking management, wherein a parking management communication module is installed at every parking section of a parking area. A parking management central server receives parking information transmitted from a plurality of parking management communication modules through a mobile communication network or a private wireless network, integrally manages the information, and settles up a parking fee. A mobile communication server confirms a resident registration number and approves settlement; a parking manager mobile phone or other communication device receives a text message from the parking management central server. A telephone line connects the mobile communication server and the car owner mobile phone with the parking management central server.

Though all above mentioned inventions describes the use of mobile phone or pager like devices to do the payment of parking but either it requires some apparatus to be placed in the parked car or else requires some ticket wending machine in the parking lot. But when car is parked in some open street or in unmanned parking area, such devices may not give practical solution of the payment of parking. Over and above at different location in the city, depending on the congestion of the area, the charges of parking are different and maximum allowable times are also different. In such condition, system available in prior art do not address the issue.

The present invention deals with providing a system wherein when the user start the application from his geo-location enabled device like smart phone or laptop or such kind of devices, it will send the message to centralized server, which will take record of the time of car parked in particular area and when user end the application, calculate the total charges of parking fees depending on the rate of parking prevailing in that geo-location. Users can do the payment by mobile or net banking or by credit card, which can be recorded in real time by centralized server and acknowledgement of the paid receipt will be sent in real time. This invention do not require any special instrument or device to be placed in the parking lot or in the car and hence will reduce the cost of installment and maintenance of such device and also reduce the expenditure on human resources required to monitor the parking lot.

### OBJECTIVES OF THE INVENTION

The main objective the present invention is to provide a system for centralized payment of parking using geo-location enabled devices in such a way that accurate calculation and payment of parking fees done even when the parking is done in the open street or in unmanned area.

Another objective is to provide an effective means to the police or parking manager to monitor and track the payment done by the user is appropriate or not.

Another objective is to replace the use of parking meters and thereby reduce the cost required for new installation and maintenance of thousands of parking meters.

Yet another objective is to provide easy transaction of the payment by the user and reduce the avoidance to parking regulating authority to collect money (coins) from each of the parking places.

Further objective is to provide convenience to end user to pay for parking without searching for coins and also estimating what is the right amount of parking time; as sometimes meeting are completed in few minutes sometimes it goes much longer. Lastly to provide location based services to the driver.

### SUMMARY OF INVENTION

Thus according to one aspect of the present invention, there is provided a system for centralized payment of parking using geo-location enabled devices in such a way that accurate calculation and payment of parking fees done even when the parking is done in the open street or in unmanned area.

According to another aspect of present invention, there is provided a method of online payment for paid parking area using centralized server based system.

According to further aspect of present invention, there is provided a system for police or parking manager to check whether payment done by user or not.

According to another aspect of present invention, there is provided a system which can able to take record of customer profile along with the details of his vehicle, which can be useful to trace the record of any suspected vehicle.

According to another aspect of present invention, there is provided a system which can use Optical Corrector Recognition (OCR) in backend to decrypt the photo of the vehicle number plate to recognize the vehicle.

According to further aspect of present invention, there is provided a system which can alternatively uses barcode to identify the vehicle, wherein customers who enroll in the program get a free barcode for each vehicle they have registered.

According to further aspect of present invention, there is provided a system through which location of the vehicle is verified by knowing the location of the Parking enforcement Officer's phone.

### BRIEF DESCRIPTION OF THE INVENTION

The present invention provides a centralized parking payment and monitoring system using geo-location enabled devices.

Some preferred forms of the invention are shown in the drawings in which

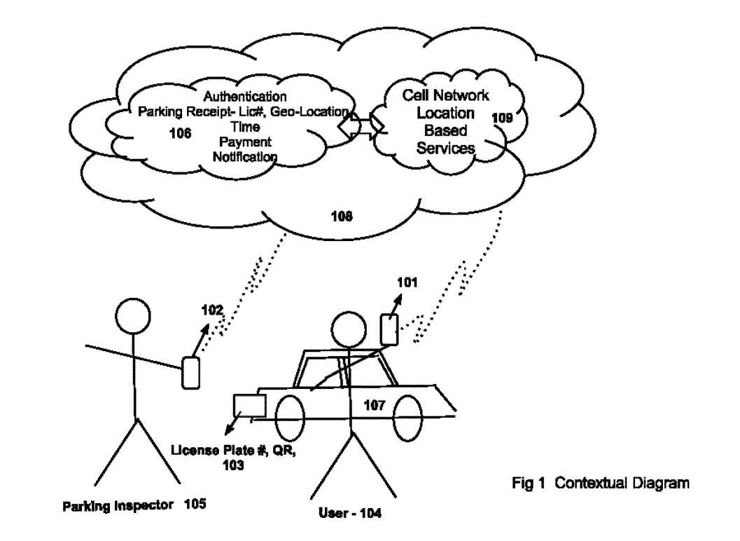

FIG. 1 represents the contextual diagram of the present invented system

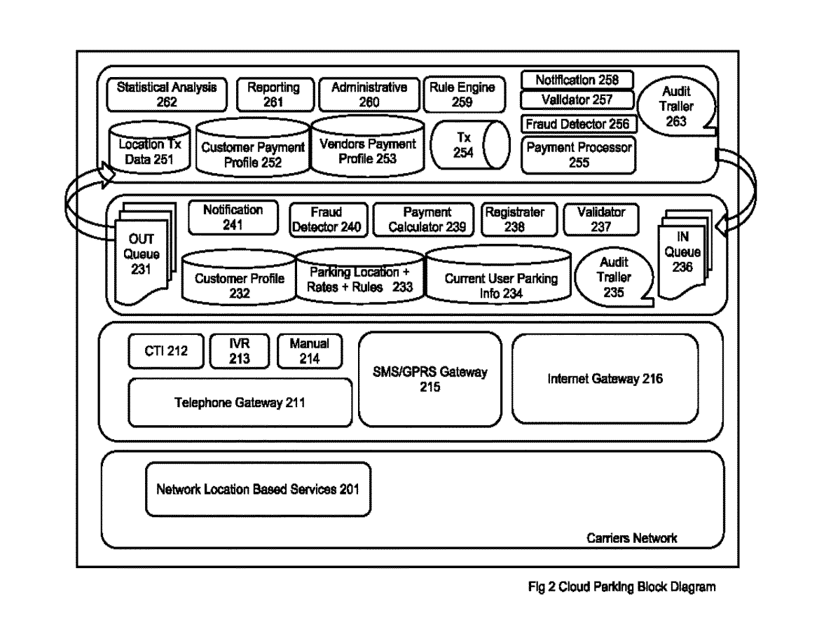

FIG. 2 represents the block diagram of the present invented system

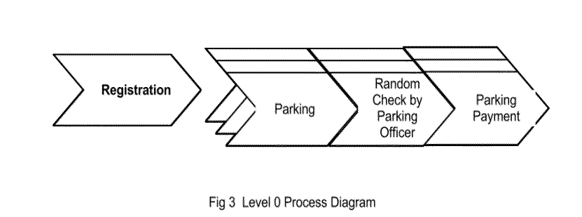

FIGS. 3, 4, 5 and 6 represents the flow diagrams of the invented system.

### DETAILED DESCRIPTION

There are four major components as shown in FIG. 1 (a) A geo-location enabled device (101) owned by the user (104), who is parking the vehicle (107); (b) A geo-location enabled device (102) used by the parking enforcement officer (105); (c) Cloud based parking system (106) to keep track of virtual parking receipts, for issuing parking violation tickets and for performing parking payment transactions and (d) Cell network which includes Location Based Services (LBS)(109).

FIG. 1. shows the contextual diagram of the operation where person (104) parks the vehicle (107) and uses his geo-location enabled device (101) to inform the cloud parking system (106) about the parking so it creates virtual parking receipt. The location is provided by the GPS in the device or Location based service available in the cloud provided by carrier network. There can be various parking plans such as hourly prepaid, all day/week/month pre-paid pass, or pay at the end for number of hours/minutes parked. The different parking plans are not limited to what is described but can support multiple plans and their combination as complex rules can be built in the rule engine (252).

Police or parking enforcement officer (105) uses the other application on the geo-location enabled device (102) as shown in FIG. 1 to check the Vehicle License Plate number or barcode (103) to check the virtual parking receipt in the centralize cloud. This whole design doesn't need parking meter or sensors or other equipment or any other marking at the parking location for system to work thereby reducing the infrastructure implementation and maintenance costs.

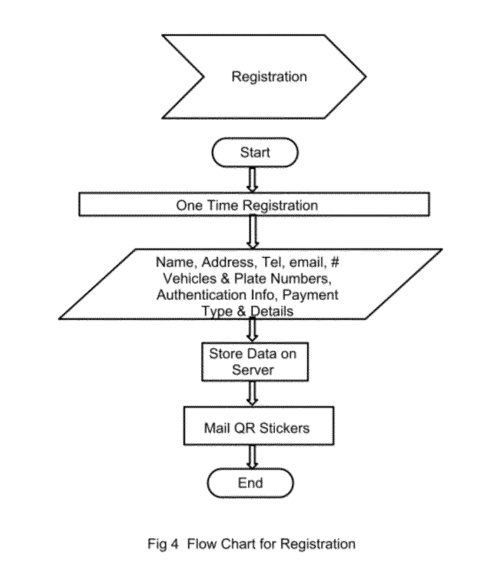

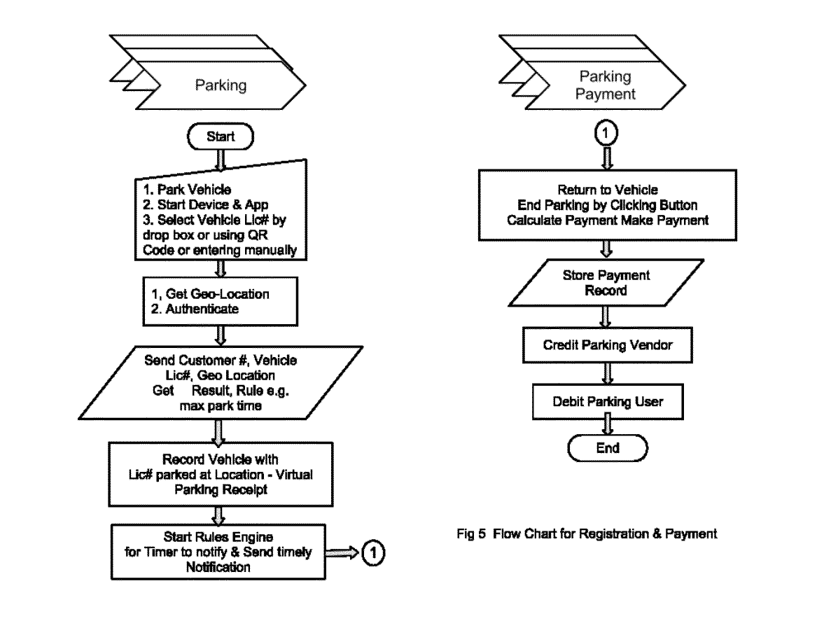

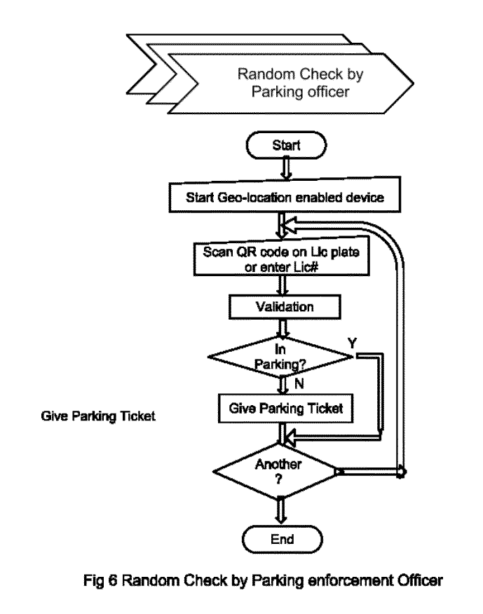

The process is described in more detail using FIG. 2, FIG. 3, FIG. 4, FIG. 5 and FIG. 6.

User downloads the Application on their geo-enabled device and installs and configures it as one time registration process as shown in FIG. 3. under registration chevron by providing Name, Address, vehicle license(s) number, Authentication information and method of payment type and other payment details. Registration is one time operation and done using user interface (201). Alternative can be provided where one time registration can be performed using web application though computer (216) and then mobile app is configured with the user authentication credentials. User can enter multiple vehicle license number at one time and also define the default vehicle. Or user can also register by calling on the phone using a live operator or using Interactive Voice Recognition (IVR) (213) system or by using computer telephone interactive (CTI) (214) application or by sending SMS/GPRS message (215).

The profile of the user is kept on the central server with payment method, vehicle numbers and user address (232). This prevents loss of information if phone is lost or stopped working or system installed on any other devices. The default vehicle can be specified for a particular geo-location device. This functionality is useful in case, where users can share the same parking account in their family and each family member can have a different default license plate for their vehicle. The basic user profile information is stored in Customer Profile (232), while more financial sensitive information is stored in Customer Payment Profile (252). Customer authentication information can be stored in the device in encrypted form using security library (206). A QR sticker can be provided which would be placed on the vehicle (107). This QR code (103) can be scanned using the camera fitted in the parking lot and can be used by the user or the parking officer to identify the parked vehicle and does not require entering the vehicle number manually. The other option is to use image recognition by taking the picture of the License plate number. The information is shared with the cloud parking system using WiFi or Wireless data network (108).

As show in FIG. 4, the parking process starts with user parking the vehicle in the parking place and starting the application which logs into cloud parking system (106) to get the virtual parking receipt by providing Geo-location, License Plate number. The entry can be most easily done by user using user interface on device or sending SMS message or calling the phone number using mobile device. User can override the default vehicle number and select parking options based on the location or conditions specified by the parking company. In case user has geo location device like wireless-laptop they use web application to start parking (216).

If geo-location enabled devices that don't have local GPS, they use network based location based services (201). Some smart phones augment the accuracy of the GPS by using network based location services (201). User having geo-location enabled simple mobile phones, parks their vehicle at the appropriate parking space and uses normal cell phone to call a specified number. The Computer Telephone Interface (CTI) (213) and Interactive Voice Response (IVR) (214) applications in the cloud responds back and uses location based services from the cell network service provider to locate user.

The application can be started by clicking Start button or by voice command to inform the cloud system about parking of the vehicle. As the cloud already has License Plate number stored during the registration process in the system, user does not need to re-enter the same.

In another embodiment of the present invention, if the vehicle is new or rental or a borrowed one, user can overwrite the default by entering the new vehicle license plate number.

Still in another embodiment of the present invention, the information about the location can be send by SMS message to SMS gateway (215) connected to the cloud parking system. The SMS message includes the details like user identification number, vehicle license plate number and starting command for parking.

Yet in another embodiment of the present invention, there is provided an alternative for non registered users, wherein user can go online through internet or may call to the tall free number and provides location details along with timing.

Still in another embodiment of the present invention, there is provided multiple payment plans duly supported by the centralized cloud system, which includes pre-pay for fix time, pay at the end of parking based on actual parking time or even a whole day parking pass. Also notification can be provided from the cloud parking system by sub-systems (241) and (258).

Yet in another embodiment of the present invention, the parking application sends notification to the user when he/she is going over the parking limits or parking lot is going to close.

Still in another embodiment of the present invention, when the geo-location enabled devices are not notification enabled then the system can notify by calling on their phone or by sending an SMS/GPRS message based on user preferences.

User when returns to the vehicle, he/she stop the parking application on the geo-location enabled device using user interface as depicted by workflow under ‘Parking Payment’ in FIG. 5.

Yet in another embodiment of the present invention, the user who has geo-location enabled simple mobile phone can dial the toll free phone number using their cell phone. The CTI and IVR enabled cloud parking system takes the call and based on the options selected, it would end the parking.

Still in another embodiment of the present invention, the user can able to send a SMS cryptic message to SMS gateway connected to the cloud parking system. The SMS cryptic messages could be password, and end parking command using cell phone.

Yet in another embodiment of the present invention, the payment will be calculated (239) for the parking and credited using set of systems (252, 253, 254, 255 and 259) to the parking authority based on the financial agreement signed. The system calculates the amount of money to be paid and shows to the user and charges it to his/her credit card or other payment method as specified in the profile and credits that amount to the party owning the parking meter subtracting agreed upon service charge.

In another embodiment of the present invention, there is provided the cloud parking system which completes the parking transaction by debiting the user account by amount equal to the parking and credits the parking entity's account according the business agreement.

Still in another embodiment of the present invention, there is provided the fraud prevention system (240 and 256) to reduce the frauds committed.

Yet in another embodiment of the present invention, there is provided a system wherein if user forgets to click complete parking and drive away then the application will send notification to the user based on the amount of distance they are away from the active parked location and speed of the person carrying the smart phone is moving.

Still in another embodiment of the present invention, wherein the parking enforcement officer uses a enforcement application to verify if the vehicle has a parking receipt as depicted in FIG. 6 under the Chevron ‘Random Check by Parking Officer’. The officer uses the camera to read QR code to identify the vehicle or they can enter the License Plate number or take a photo of the license Plate number which is then OCR to be recognized.

Yet in another embodiment of the present invention, wherein the enforcement officer can check for parking violation in running the enforcement application on the smart phone or in their geo-location enabled devices like laptop, palmtop or any other device and enters the vehicle number to check if the vehicle has any violation.

Still in another embodiment of the present invention, wherein the enforcement application can show the vehicles parked near the location they are standing, using the geo-location of their co-ordinates.

Yet in another embodiment of the present invention, wherein the parking enforcement officers having simple geo-enabled mobile phone can check whether the vehicle parking is being paid or time is up by calling the phone number of the parking cloud service and entering the their personal password, vehicle license number, the CTI (212) and IVR (213) enabled parking enforcement application running on cloud will provide the answer.

Still in another embodiment of the present invention, wherein the other option is to send a SMS cryptic message to SMS gateway connected to the cloud parking system. The SMS cryptic messages could be password, vehicle license plate number and validate parking command using cell phone. The cloud responds by SMS message where that vehicle has virtual parking payment receipt.

Yet in another embodiment of the present invention, wherein if there is parking violation then enforcement officer can able to generate a ticket using ticket functionality available in centralized cloud system and send to the user's geo-enabled device.

Still in another embodiment of the present invention, wherein ticket can also be printed by officer using portable printer or can be manually written and put on parked vehicle.

Yet in another embodiment of the present invention, wherein the said system can work with multiple parking authorities or companies as it can identify the parking location due to location information provided by the smart phone or above mentioned geo-location enabled devices. Also, it can enforce different rules and parking rates based on the parking lot or place it is parked on.

Still in another embodiment of the present invention, wherein the said system can able to identify the geo-location of the particular vehicle when parked in the particular Parking Area.

Yet in another embodiment of the present invention, the system provides the set rules for parking and its payment rate depending on particular geo location of Parking Area. To do so system provides three types of admin instructions to identify parking areas like;
(a) Admin-1—Texture Representation—Name of County/District/State
(b) Admin-2—Texture Representation—City/Administrative Area
(c) Admin-3—Latitude, Longitude co-ordinates of the polygon representing the place. Also, define the rectangle Latitude, Longitude co-ordinate surrounding the polygon for quick filtering out
   When the vehicle is parked and system will started, initially it will search for Admin-3 to identify the set rules for said location using the data received from the location based services. If it cannot find any Parking Area linked with Admin-3, it will search for Admin-2 or Admin-1 using data received from reverse geo-location service call.

In brief, the present invention provide a most convenient way of payment and monitoring of parking by using the system on smart phone or any other geo-location enabled devices like pager, laptop, palmtop or others, particularly in open street or unmanned parking area. The design doesn't require any new infrastructure to be created or marked on the road. This will save time and money both from user side and regulatory agency side.

Although the preferred embodiment as well as the preparation and use have been specifically described, it should be understood that variations in the preferred embodiment could be achieved by a person skilled in the art without departing from the spirit of the invention. The invention has been described with reference to specific embodiments which are merely illustrative and not intended to limit the scope of the invention as defined in the claims.

I claim:

1. The centralized parking system for a plurality of parking spaces, comprises of,
centralized cloud system (106) consisting of large number of virtual servers running on one or more physical servers depending on number of users,
geo location enabled device (102) for enforcement officer (105) which has one to more processors coupled with dynamic memory, flash memory to store the programs, GPS (Global positioning system) and display,
geo location enabled device (101) for the user (104) which has one or more processor with memory and display. Typically it will be smart phone which is carried by large number of users driving vehicles.

2. The centralized parking system as claimed in claim 1, wherein said geo location enabled device (101, 102) is pager, ordinary mobile, smart phone, laptop or palmtop like device. In case of devices without GPS, LBS from carrier network will be used to identify the geo-location (026). It uses LBS to identify the Parking Area where the call is coming from

3. The centralized parking system as claimed in claim 1, wherein geo location enabled device is connected with centralized cloud system (106) and work without needing parking sensor, meters or markers.

4. The centralized parking system as claimed in claim 1, wherein said parking system supports multiplicity of geo-location enabled devices, license plates, family sub accounts, default license plate per device and over-riding of the license plate in case of rental vehicle.

5. The centralized parking system as claimed in claim 1, wherein it supports multiple plans and their combination to implement parking payment system in any part of the city, on any road in the city with single or paid parking spaces throughout the city as a tourist visiting different parts of the city using day pass.

6. The centralized parking system as claimed in claim 1, wherein the said system has fraud detection (240) and notification system (241) to send alert the geo location enabled device (101, 102) of parking user (104) and parking enforcement officer (106).

7. The centralized parking system as claimed in claim 1, wherein the said system send alert message that virtual parking is still on to the geo location enabled device (101) of the user (104) when he is moving away from the parking area with speed of more than 10 miles/h.

8. The centralized parking system as claimed in claim 1, wherein said geo location enabled device (101, 102) capture signal of GPS or LBS (Location based System) (109) or both to identify location of parking area and not of parking location (spot). The system tracks the vehicle by Parking Area (004, 059) instead of specific parking location (spot), Parking area is like a Geo-fencing of a large area such as a whole street or large parking area. This is a big change in process that supports current GPS or LBS technologies which cannot identify vehicle to parking slot can work very well with Parking Area, If there is another Parking Area very close by within the accuracy of the GPS or LBS then user is prompted to select between the Parking Areas where they are parking. The selection of Parking Areas given is based on the accuracy of GPS or LBS used to identify Parking Area,

9. The centralized parking system as claimed in claim 1, wherein said parking system identifies vehicle parked in any parking area or even across parking Areas.

10. The centralized parking payment and monitoring system as claimed in claim 3, wherein said application has centralized data storage which store the profile data of the user with payment ethod, vehicle numbers and user address for enabling administrative to access and reporting the user and parking vendor payment profile.

11. The centralized parking system as claimed in claim 1, wherein the enforcement officer (106) check parking violation by running the enforcement program (FIG. 6) on his geo location enabled device (102) by entering the vehicle license number to check if the vehicle has virtual parking ticket or not.

12. Central cloud parking system (106) keep tracks of currently parked vehicle using Parking Area, Virtual Parking tickets and uses sophisticated Business Intelligence to generate reports to identify empty spaces and places where vehicles are not paying parking

13. A method of centralized parking system using geo location enabled devices that uses no devices or unique identification marking on the parking spot comprising following steps;
installing a parking program in geo-location enabled device (101) of the users (104) for identifying parking area,
clicking start button on the parking application,
identification of the location of the user (104) who is parking the vehicle (107) using simple mobile device even without GPS,
tracking of currently parked vehicle using parking area, virtual parking tickets and generating reports to identify empty spaces and places where vehicles are not paying parking,
installing an enforcement application on geo location enabled enforcement device of parking enforcement officer/police officer (105) to check the status if the vehicle has valid virtual parking ticket, connect to geo-location enabled device
